(19) United States
(12) Patent Application Publication
(10) Pub. No.: US 2025/0026259 A1
(43) Pub. Date: Jan. 23, 2025

(54) LIGHT DISTRIBUTION CONTROL DEVICE, HEADLIGHT DEVICE, AND LIGHT DISTRIBUTION CONTROL METHOD

(71) Applicant: Mitsubishi Electric Corporation, Tokyo (JP)

(72) Inventors: Ayumi NISHIKAWA, Tokyo (JP); Takayoshi CHIKURI, Tokyo (JP); Hiroki NAKAMOTO, Tokyo (JP); Satoru INOUE, Tokyo (JP)

(73) Assignee: Mitsubishi Electric Corporation, Tokyo (JP)

(21) Appl. No.: 18/715,486

(22) PCT Filed: Jan. 17, 2022
(86) PCT No.: PCT/JP2022/001256

§ 371 Date: May 31, 2024

(51) Int. Cl. B60Q 1/14; F21S 41/663; F21Y 115/10; H05B 47/125

(52) U.S. Cl. CPC B60Q 1/1423; F21S 41/663; H05B 47/125; B60Q 2300/056; F21Y 2115/10

(57) ABSTRACT

A light distribution control device controls a high beam emitter capable of dividing a high beam irradiation area into a plurality of areas and includes processing circuitry configured to; detect whether or not an irradiation target to be irradiated with a high beam or a light shielding target to be shielded from the high beam is present in the high beam irradiation area; determine a light shielding region for shielding the light shielding target when the light shielding target is detected; calculate an optical axis adjustment amount for adjusting a direction of an optical axis of the high beam emitter in such a manner that the irradiation target is out of the light shielding region when the irradiation target is included in the light shielding region; and control the optical axis of the high beam emitter on a basis of the optical axis adjustment amount.

### TECHNICAL FIELD

The present disclosure relates to a light distribution control technology for controlling light distribution of a headlight of a vehicle.

### BACKGROUND ART

Among light distribution control technologies for headlights, there is a technology for suppressing glare (dazzling light) caused by a high beam of a headlight from being given to a driver of another vehicle.

Patent Literature 1 discloses a vehicle headlamp capable of suppressing irradiation of an irradiation prohibited target, which is another vehicle, with a high beam.

Specifically, the vehicle headlamp turns off the high beam unit for a high beam irradiation area in which an irradiation prohibition target is present when the presence of the irradiation prohibition target is detected among a plurality of high beam irradiation areas arranged ahead of the vehicle.

### CITATION LIST

### Patent Literature

Patent Literature 1: JP 2008-037240 A

### SUMMARY OF INVENTION

### Technical Problem

However, the vehicle headlamp disclosed in Patent Literature 1 has a problem that, when an obstacle to be originally irradiated with a high beam together with an irradiation prohibition target is present in each high beam irradiation area of a plurality of high beam irradiation areas, the obstacle is not irradiated.

The present disclosure has been made to solve the above problems, and an object of the present disclosure is to provide a light distribution control device capable of irradiating an irradiation target with a high beam even when an irradiation target is present, which is an obstacle to be originally irradiated with the high beam, together with a light shielding target that is an irradiation prohibition target, in each high beam irradiation area of a plurality of high beam irradiation areas.

### Solution to Problem

A light distribution control device of the present disclosure is a light distribution control device that controls a high beam unit capable of dividing a high beam irradiation area into a plurality of areas, the light distribution control device including an object detecting unit to detect whether or not an irradiation target to be irradiated with a high beam or a light shielding target to be shielded from the high beam is present in the high beam irradiation area, a light shielding region determining unit to determine a light shielding region for shielding the light shielding target when the object detecting unit detects the light shielding target, an optical axis adjustment amount calculating unit to calculate an optical axis adjustment amount for adjusting a direction of an optical axis of the high beam unit in such a manner that the irradiation target is out of the light shielding region when the irradiation target is included in the light shielding region, and a light distribution control unit to control the optical axis of the high beam unit on the basis of the optical axis adjustment amount.

### Advantageous Effects of Invention

Since the present disclosure is configured as described above, it is possible to provide a light distribution control device capable of irradiating an irradiation target with a high beam even when an irradiation target is present, which is an obstacle to be originally irradiated with the high beam, together with a light shielding target that is an irradiation prohibition target, in each high beam irradiation area of a plurality of high beam irradiation areas.

### BRIEF DESCRIPTION OF DRAWINGS

FIG. 1 is a diagram illustrating a configuration example of a headlight control device including a light distribution control device according to the present disclosure and a headlight device.

FIG. 2 is a diagram illustrating a configuration example of a light distribution control device according to a first embodiment.

FIG. 3 is a flowchart illustrating an example of partial processing in the headlight control device including the light distribution control device according to the present disclosure and the headlight device.

FIGS. 4A, 4B, and 4C are flowcharts illustrating an example of light distribution control processing by the light distribution control device according to the first embodiment.

FIG. 5 is a flowchart illustrating an example of processing (first processing example) in step ST170 in FIG. 4.

FIG. 6 is a flowchart illustrating an example of processing (second processing example) in step ST170 in FIG. 4.

FIG. 7 is a flowchart illustrating an example of processing (third processing example) in step ST170 in FIG. 4.

FIGS. 8A and 8B are diagrams illustrating an example in which it is determined in step 170 of the light distribution control processing that an irradiation target is not present in a light shielding region, FIG. 8A is an overhead view, and FIG. 8B is a diagram illustrating how a high beam irradiation area overlaps with a light shielding target and the irradiation target when looking forward from a host vehicle side.

FIGS. 9A and 9B are diagrams illustrating an example in which it is determined in step 170 of the light distribution control processing that the irradiation target is present in the light shielding region, FIG. 9A is an overhead view, and FIG. 9B is a diagram illustrating how the high beam irradiation area overlaps with the light shielding target and the irradiation target when looking forward from the host vehicle side.

FIGS. 10A and 10B are diagrams illustrating a state after an optical axis is adjusted by the light distribution control processing, FIG. 10A is an overhead view, and FIG. 10B is a diagram illustrating how the high beam irradiation area overlaps with the light shielding target and the irradiation target when looking forward from the host vehicle side.

FIG. 11 is a diagram illustrating a configuration example of a light distribution control device according to a second embodiment.

FIG. 12 is a flowchart illustrating an example of light distribution control processing by the light distribution control device according to the second embodiment.

FIGS. 13A and 13B are diagrams illustrating a state after the optical axis is adjusted by the light distribution control processing according to the first embodiment, FIG. 13A is an overhead view, and FIG. 13B is a diagram illustrating how the high beam irradiation area overlaps with the light shielding target and the irradiation target when looking forward from the host vehicle side.

FIGS. 14A and 14B are diagrams for describing a concept of the light distribution control processing according to the second embodiment, in which FIG. 14A is an overhead view, and FIG. 14B is a diagram illustrating how the high beam irradiation area overlaps with the light shielding target and the irradiation target when looking forward from the host vehicle side.

FIG. 15 is a diagram illustrating a configuration example of a light distribution control device according to a third embodiment.

FIGS. 16A and 16B are flowcharts illustrating an example of light distribution control processing by the light distribution control device according to the third embodiment.

FIGS. 17A and 17B are diagrams illustrating an example of a situation in which it is determined in step ST171 that there is a plurality of irradiation targets, FIG. 17A is an overhead view, and FIG. 17B is a diagram illustrating how the high beam irradiation area overlaps with the light shielding target and the irradiation target when looking forward from the host vehicle side.

FIGS. 18A and 18B are diagrams illustrating an example of a situation in which it is determined in step ST171 that there is a plurality of irradiation targets and it is further determined in step ST174 that there is no irradiation target in a host vehicle lane, FIG. 18A is an overhead view, and FIG. 18B is a diagram illustrating how the high beam irradiation area overlaps with the light shielding target and the irradiation target when looking forward from the host vehicle side.

FIG. 19 is a flowchart illustrating an example of light distribution control processing by a light distribution control device according to a fourth embodiment.

FIGS. 20A and 20B are diagrams illustrating an example in which it is determined in step 170 of the light distribution control processing that the irradiation target is present in the light shielding region, FIG. 20A is an overhead view, and FIG. 20B is a diagram illustrating how the high beam irradiation area overlaps with the light shielding target and the irradiation target when looking forward from the host vehicle side.

FIGS. 21A and 21B are diagrams illustrating a state after the optical axis is adjusted, FIG. 21A is an overhead view, and FIG. 21B is a diagram illustrating how the high beam irradiation area overlaps with the light shielding target and the irradiation target when looking forward from the host vehicle side.

FIGS. 22A and 22B are diagrams illustrating a state after the light shielding region is further changed, FIG. 22A is an overhead view, and FIG. 22B is a diagram illustrating how the high beam irradiation area overlaps with the light shielding target and the irradiation target when looking forward from the host vehicle side.

FIG. 23 is a diagram illustrating a first example of a hardware configuration for implementing functions according to the present disclosure.

FIG. 24 is a diagram illustrating a second example of a hardware configuration for implementing the functions according to the present disclosure.

### DESCRIPTION OF EMBODIMENTS

Hereinafter, in order to describe the present disclosure in more detail, modes for carrying out the present disclosure will be described with reference to the accompanying drawings.

Alight distribution control technology according to an embodiment of the present disclosure relates to a technology in which, while maintaining visibility by irradiating in front of a host vehicle with a high beam, irradiation with the high beam is not performed only in a region where other vehicles are present (hereinafter, light shielding) in order to prevent drivers of other vehicles (preceding vehicle and oncoming vehicle) from being dazzled (glared) by irradiation light.

This light shielding technology is called adaptive driving beam (ADB).

One of the ADB systems is an LED array system.

This is a system in which a high beam is divided by a plurality of LEDs (LED modules) and irradiated, and is a system in which turning on or off of each LED is switched depending on a region irradiated by each LED and a region desired to be shielded from light (a region where another vehicle is present).

In each embodiment, a light distribution control technology of the present disclosure applied to the above technology will be described.

### First Embodiment

In a first embodiment, a mode will be described in which, in a case where an irradiation target is included in a light shielding region, the irradiation target is out of the light shielding region by adjusting the optical axis.

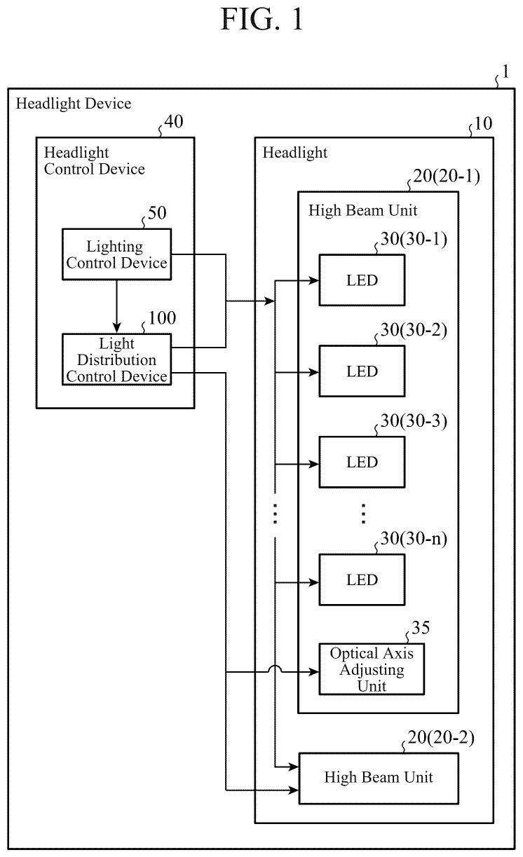

FIG. 1 is a diagram illustrating a configuration example of a headlight control device 40 including a light distribution control device 100 according to the present disclosure and a headlight device 1.

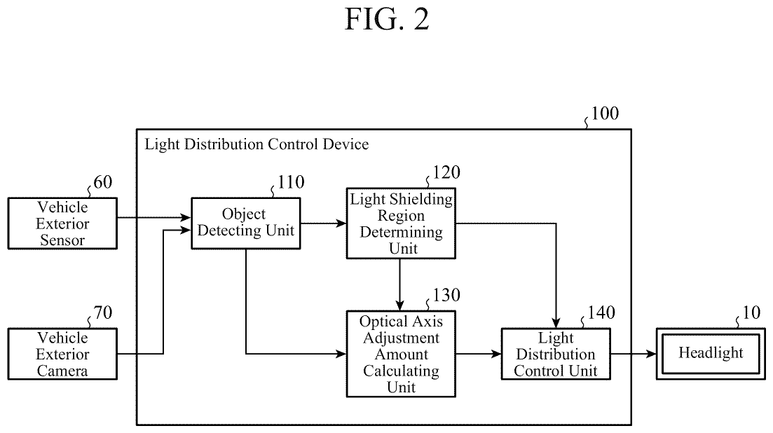

FIG. 2 is a diagram illustrating a configuration example of the light distribution control device 100 according to the first embodiment.

The headlight device 1 illustrated in FIG. 1 includes a headlight 10 and the headlight control device 40.

The headlight 10 is a lighting fixture that illuminates in front of the host vehicle.

The headlight 10 operates under control of the headlight control device 40.

The headlight 10 includes a low beam unit (not illustrated) and a high beam unit 20.

The low beam unit illuminates a near side with respect to the host vehicle, and the high beam unit 20 illuminates a far side with respect to the host vehicle.

The headlight 10 illustrated in FIG. 1 includes two high beam units 20.

The two high beam units 20 are arranged on the left side and the right side of the vehicle in the front direction.

Hereinafter, the two high beam units 20 will be described without distinction unless it is necessary to separately describe the left and right high beam units 20.

The high beam unit 20 includes a plurality of LEDs 30 and an optical axis adjusting unit 35.

Each of the plurality of LEDs 30 is a light source for a high beam, and each of the LEDs 30 is, for example, an LED module including LED arrays arranged in an array. Hereinafter, the LED 30 illustrated in FIG. 1 is referred to as an “LED module 30”.

A plurality of LED modules 30 is configured to be capable of individually turning on or off.

The plurality of LED modules 30 is assigned LED numbers which are identification information for identifying each of the LED modules.

The LED number individually corresponds to each high beam irradiation area that is a region irradiated with the high beam by each LED module 30, and is used for light distribution control processing.

The high beam unit 20 irradiates a plurality of high beam irradiation areas corresponding to each LED module 30 with a high beam.

In other words, the high beam unit 20 configured in this manner is a high beam unit capable of dividing a high beam irradiation area into a plurality of high beam irradiation areas, and can individually turn on or off each of the plurality of divided high beam irradiation areas.

Note that, when the plurality of high beam units 20 is employed, some or all of the high beam irradiation areas by the LED modules 30 in each of the plurality of high beam units 20 may overlap with each other. For example, each high beam irradiation area by the LED modules 30-1, 30-2, 30-3, . . . , 30-n (n is any natural number) in a high beam unit 20-1 illustrated in FIG. 1 and each high beam irradiation area by the plurality of LED modules 30 (not illustrated) in a high beam unit 20-2 may be configured to overlap with each other.

The optical axis adjusting unit 35 is configured to be capable of changing the optical axis of the high beam unit 20 upon receiving a control signal indicating an optical axis adjustment amount and an adjustment direction from the light distribution control device 100. The optical axis adjusting unit 35 can change the optical axis at least in a left-right direction with reference to the host vehicle. The optical axis adjusting unit 35 has, for example, a mechanism that physically inclines the high beam unit 20 itself.

The headlight control device 40 includes a lighting control device 50 and a light distribution control device 100.

The lighting control device 50 controls lighting of the headlight 10. The lighting control device 50 controls turning on and off of the high beam of the headlight 10, for example.

The light distribution control device 100 is communicably connected to each of a vehicle exterior sensor 60, a vehicle exterior camera 70, and the headlight 10.

The light distribution control device 100 controls a light distribution of the high beam of the headlight 10.

The vehicle exterior sensor 60 is a sensor mounted on a vehicle. The vehicle exterior sensor 60 outputs sensor data regarding an object outside the vehicle.

The vehicle exterior sensor 60 detects sensor data information that allows obtaining, for example, an object being present ahead of the host vehicle, a size of the object, a shape of the object, a distance from the host vehicle to the object, and the like.

The vehicle exterior sensor 60 is, for example, a millimeter wave radar or a light detection and ranging (LiDAR).

The vehicle exterior camera 70 is a camera mounted on the vehicle, and images in front of the vehicle on which it is mounted. The vehicle exterior camera 70 is mounted on the host vehicle, and outputs image data that is an image obtained by imaging in front of the host vehicle.

The vehicle exterior camera 70 is, for example, a stereo camera that images ahead of the vehicle.

The light distribution control device 100 is a device that receives sensor data output from the vehicle exterior sensor 60 and image data output from the vehicle exterior camera 70, executes the light distribution control processing using the sensor data and the image data, and controls the headlight 10.

The light distribution control device 100 controls the high beam unit 20 in the headlight 10 capable of dividing a high beam irradiation area into a plurality of areas.

The light distribution control device 100 illustrated in FIG. 2 includes an object detecting unit 110, a light shielding region determining unit 120, an optical axis adjustment amount calculating unit 130, and a light distribution control unit 140.

The object detecting unit 110 detects whether or not an irradiation target to be irradiated with a high beam or a light shielding target to be shielded from the high beam is present in a high beam irradiation area.

The light shielding target is an object that should not be irradiated with a high beam. The light shielding target is, for example, a preceding vehicle or an oncoming vehicle present ahead of the host vehicle. The preceding vehicle and the oncoming vehicle that are light shielding targets include a vehicle that is traveling (hereinafter, also referred to as a “traveling vehicle”) or a vehicle that is temporarily stopped with lights on (hereinafter, also referred to as a “vehicle stopped with lights on”). When these are irradiated with a high beam, glare is generated for an occupant of a preceding vehicle or an oncoming vehicle.

The irradiation target is an object to be irradiated with a high beam. Examples thereof include a vehicle that stops with no lights on (hereinafter, also referred to as a “vehicle stopped with no lights on”) on a road shoulder ahead of the host vehicle, and a fallen object on a road. If the region including these is shielded from light, finding by the user is delayed, and there is a risk of collision.

Specifically, the object detecting unit 110 acquires sensor data from the vehicle exterior sensor 60, acquires image data from the vehicle exterior camera 70, and detects an object present ahead of the host vehicle using these pieces of information.

The object detecting unit 110 determines whether an object is a light shielding target or an irradiation target from among detected objects, and acquires respective pieces of information (position ahead of the host vehicle or distance from the host vehicle, size, or the like).

The object detecting unit 110 outputs light shielding target information and irradiation target information.

The light shielding target information includes a positional relationship between the host vehicle and a light shielding target and a size of the light shielding target.

The irradiation target information includes a positional relationship between the host vehicle and an irradiation target and a size of the irradiation target.

Information indicating the positional relationship is in the form of, for example, a distance from the host vehicle and coordinates based on the host vehicle.

Information indicating the size is in the form of, for example, an area when viewed from the host vehicle.

More specifically, the object detecting unit 110 compares, for example, the sensor data and the image data by aligning their positions. The sensor data and the image data can be compared by, for example, corresponding to each predetermined coordinate in each of the sensor data and the image data. The object detecting unit 110 checks whether regions of lights (headlights, tail lamps, and the like of other vehicles) indicated in the image data overlap with a region of an object indicated in the sensor data. The regions of lights are obtained by image analysis.

When the region of an object and the region of a light overlap with each other, that is, when the object and the light are at the same position, the object detecting unit 110 determines that the object is a light shielding target such as another vehicle (preceding vehicle or oncoming vehicle) that is traveling or stopped with lights on. The object detecting unit 110 outputs the light shielding target information for the determined light shielding target.

When the region of an object and the region of a light do not overlap with each other, that is, when there is no light at the position of the object, the object detecting unit 110 determines that the object is an irradiation target such as another vehicle that is parked or stopped with no lights on or a fallen object. The object detecting unit 110 outputs the irradiation target information regarding the determined irradiation target.

Furthermore, in addition to the above, the object detecting unit 110 acquires a light amount of the light on the basis of the sensor data or the image data, and uses the light amount of the light.

For example, when the region of an object and the region of a light overlap with each other and the light amount of the light is equal to or more than a threshold (predetermined light amount), the object detecting unit 110 determines that the vehicle is another vehicle that is traveling (traveling vehicle) with lights on or another vehicle that is stopped with lights on (vehicle stopped with lights on), and determines that the vehicle is a light shielding target. Thus, for example, it is possible to determine, as a light shielding target, a vehicle stopped with lights on, which is just stopped by waiting for a traffic light or the like and on which an occupant is riding. Similarly to the above, the object detecting unit 110 outputs the light shielding target information for the determined light shielding target.

For example, when the region of an object and the region of a light overlap with each other and the light amount of the light is less than the threshold, the object detecting unit 110 determines that the vehicle is another vehicle that is stopped with no lights on (vehicle stopped with no lights on), and determines that the vehicle is an irradiation target. Thus, for example, it is possible to determine, as an irradiation target, a vehicle stopped with no lights on that merely reflects external light by a reflector or the like at the rear of the vehicle. The object detecting unit 110 outputs the irradiation target information regarding the determined irradiation target similarly to the above.

In addition, the object detecting unit 110 may determine whether an object indicated by the sensor data and an object indicated by the image data are in a moving state or a stopped state, and determine whether it is a light shielding target or an irradiation target using a result of the determination.

Note that, in the present disclosure, it is assumed that a living being such as a person or an animal is determined as an irradiation target among objects other than a vehicle. Alternatively, it may be configured to determine a person as a light shielding target.

When the object detecting unit 110 detects a light shielding target, the light shielding region determining unit 120 determines a light shielding region for shielding the light shielding target.

The light shielding region determining unit 120 acquires the light shielding target information from the object detecting unit 110.

The light shielding target information includes a positional relationship between the host vehicle and the light shielding target and a size of the light shielding target.

Using these pieces of information, the light shielding region determining unit 120 acquires identification information (light shielding LED number) of LED modules 30 to be turned off and a region (light shielding region) shielded by turning off these LED modules.

Furthermore, the light shielding region determining unit 120 acquires a region (irradiation region) irradiated by the LED module 30 that does not correspond to the light shielding LED number.

The light shielding region determining unit 120 outputs information indicating the light shielding LED number, information indicating the light shielding region, and information indicating the irradiation region.

In a case where an irradiation target is included in the light shielding region, the optical axis adjustment amount calculating unit 130 calculates an optical axis adjustment amount for adjusting the optical axis of the high beam unit 20 in such a manner that the irradiation target is out of the light shielding region.

Specifically, the optical axis adjustment amount calculating unit 130 acquires the irradiation target information and the light shielding target information from the object detecting unit 110, and acquires the light shielding region from the light shielding region determining unit 120.

The irradiation target information includes a positional relationship between the host vehicle and the irradiation target and a size of the irradiation target.

The optical axis adjustment amount calculating unit 130 compares the irradiation target information with the light shielding region, and determines whether the irradiation target is included in the light shielding region.

The optical axis adjustment amount calculating unit 130 acquires the optical axis adjustment amount and the adjustment direction depending on the determination result.

The optical axis adjustment amount calculating unit 130 outputs adjustment information indicating the optical axis adjustment amount and the adjustment direction.

The adjustment information may be, for example, an optical axis adjustment amount including positive and negative.

More specifically, for example, the optical axis adjustment amount calculating unit 130 calculates a degree to which the irradiation target is included in the light shielding region, and calculates the optical axis adjustment amount when the degree is equal to or more than a predetermined threshold.

Further, the optical axis adjustment amount calculating unit 130 calculates the optical axis adjustment amount, for example, in a case where the irradiation target is included in the light shielding region and the distance between the host vehicle and the irradiation target is equal to or less than a predetermined distance.

Further, the optical axis adjustment amount calculating unit 130 calculates the optical axis adjustment amount, for example, in a case where an expected arrival time until the host vehicle reaches the irradiation target is equal to or less than a predetermined arrival time threshold.

The light distribution control unit 140 controls the high beam unit 20 in such a manner that the irradiation target is out of the light shielding region determined by the light shielding region determining unit 120.

Specifically, the light distribution control unit 140 acquires the light shielding LED number from the light shielding region determining unit 120, and acquires the optical axis adjustment amount and the adjustment direction from the optical axis adjustment amount calculating unit 130. The light distribution control unit 140 generates a control signal for controlling the high beam unit 20 of the headlight 10 using the acquired information.

By outputting the generated control signal to the headlight 10, the light distribution control unit 140 gives a command to turn off or on each LED module 30 in the high beam unit 20 and gives a command to change the optical axis of the high beam unit 20.

More specifically, upon acquiring the light shielding LED number from the light shielding region determining unit 120, the light distribution control unit 140 gives a command the LED module 30 corresponding to the light shielding LED number to change from the on state to the off state.

Further, upon acquiring the adjustment information indicating the optical axis adjustment amount and the adjustment direction from the optical axis adjustment amount calculating unit 130, the light distribution control unit 140 controls the optical axis of the high beam unit 20 on the basis of the optical axis adjustment amount and the adjustment direction.

Processing related to the light distribution control device 100 will be described.

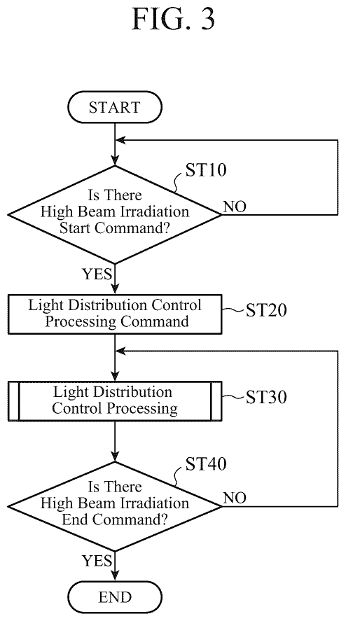

FIG. 3 is a flowchart illustrating an example of partial processing in the headlight control device 40 including the light distribution control device 100 according to the present disclosure and the headlight device 1.

For example, when the headlight is turned on, the headlight control device 40 checks whether there is a high beam irradiation start command (step ST10).

Upon receiving the high beam irradiation start command, the lighting control device 50 in the headlight control device 40 executes the high beam lighting processing and issues a light distribution control processing command (step ST20) to the light distribution control device 100.

Upon receiving the light distribution control processing command from the lighting control device 50, the light distribution control device 100 executes the light distribution control processing (step ST30).

The light distribution control device 100 executes the light distribution control processing and checks whether a high beam irradiation end command has been received (step ST40).

In a case where the high beam irradiation end command has not been received (step ST40 “NO”), the light distribution control device 100 repeats the light distribution control processing (step ST30).

In a case where the high beam irradiation end command has been received (step ST40 “YES”), the processing is ended.

An example of the light distribution control processing will be described.

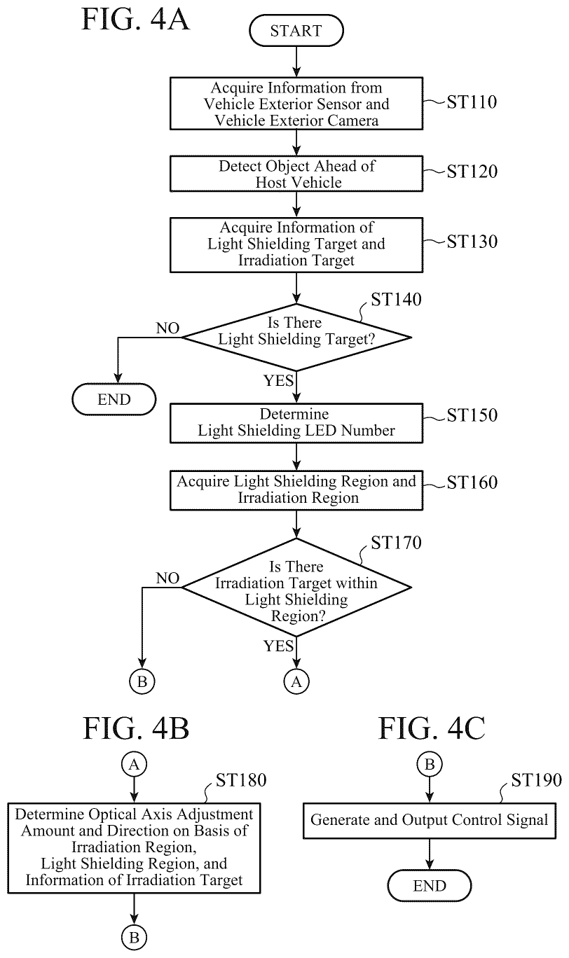

FIGS. 4A, 4B, and 4C are flowcharts illustrating an example of the light distribution control processing by the light distribution control device 100 according to the first embodiment.

When the light distribution control device 100 starts the light distribution control processing, first, the object detecting unit 110 acquires information from the vehicle exterior sensor 60 and the vehicle exterior camera 70 (step ST110).

Specifically, the object detecting unit 110 acquires sensor data from the vehicle exterior sensor 60. Further, the object detecting unit 110 acquires image data indicating a forward image from the vehicle exterior camera 70.

Next, the object detecting unit 110 detects an object ahead of the host vehicle (step ST120).

Specifically, the object detecting unit 110 detects an object being present ahead of the host vehicle using the sensor data and the image data. As a detection method, it is only necessary to use a known method, and a detailed description of an example is omitted.

Next, the object detecting unit 110 acquires the light shielding target information and the irradiation target information (step ST130).

Specifically, the object detecting unit 110 discriminates a light shielding target (preceding vehicle, oncoming vehicle, or the like) and an irradiation target (vehicle stopped on the road shoulder with no lights on, fallen object on the road, or the like) from among the detected objects, and acquires respective pieces of information (position, size, or the like).

Then, the object detecting unit 110 outputs the light shielding target information to the light shielding region determining unit 120 and the optical axis adjustment amount calculating unit 130. Further, the object detecting unit 110 outputs the irradiation target information to the optical axis adjustment amount calculating unit 130.

Next, the light shielding region determining unit 120 determines whether there is a light shielding target (step ST140).

Specifically, the light shielding region determining unit 120 acquires the light shielding target information from the object detecting unit 110, and determines whether there is a light shielding target from the acquired light shielding target information.

When the light shielding region determining unit 120 determines that there is no light shielding target (step ST140 “NO”), the light distribution control processing ends.

When the light shielding region determining unit 120 determines that there is a light shielding target (step ST140 “YES”), the light shielding region determining unit 120 determines the light shielding LED number (step ST150).

Specifically, when it is determined that there is a light shielding target, the light shielding region determining unit 120 determines the light shielding LED number using the light shielding target information. More specifically, the number of the LED in which the irradiation region of each LED module and the region where the light shielding target is present overlap with each other is determined as the light shielding LED number. As described above, the light shielding LED number is determined from the region where the light shielding target is present and the irradiation region of each LED module 30. The region where the light shielding target is present is acquired from the positional relationship between the host vehicle and the light shielding target and the size of the light shielding target. The light shielding region determining unit 120 outputs the determined light shielding LED number to the light distribution control unit 140.

Next, the light shielding region determining unit 120 acquires the light shielding region and the irradiation region (step ST160).

Specifically, the light shielding region determining unit 120 acquires the light shielding region on the basis of the light shielding LED number. The light shielding region is a region that is no longer irradiated when the LED module 30 corresponding to the light shielding LED number determined in step ST150 is turned off.

Further, at the same time, the light shielding region determining unit 120 acquires the irradiation region. The irradiation region is a region irradiated by the LED module 30 of a number not corresponding to the light shielding LED number.

Then, the light shielding region determining unit 120 outputs the acquired light shielding region and irradiation region to the optical axis adjustment amount calculating unit 130.

Next, the optical axis adjustment amount calculating unit 130 determines whether an irradiation target is present in the light shielding region (step ST170).

Specifically, for example, the optical axis adjustment amount calculating unit 130 determines whether the irradiation target is present in the light shielding region on the basis of the irradiation target information acquired from the object detecting unit 110 and the light shielding region acquired from the light shielding region determining unit 120. More specifically, from the positional relationship between the host vehicle and the irradiation target and the size of the irradiation target included in the irradiation target information, a region where the irradiation target is present when viewed from the host vehicle is acquired, and whether the region overlaps with the light shielding region is determined.

When the optical axis adjustment amount calculating unit 130 determines that the irradiation target is present in the light shielding region (step ST170 “YES”), the light distribution control processing proceeds to step ST180.

When the optical axis adjustment amount calculating unit 130 determines that the irradiation target is not present in the light shielding region (step ST170 “NO”), the light distribution control processing proceeds to step ST190.

Next, the optical axis adjustment amount calculating unit 130 determines the optical axis adjustment amount and the adjustment direction on the basis of the irradiation region, the light shielding region, and the irradiation target information (step ST180).

Specifically, for example, when it is determined that the irradiation target is present in the light shielding region (step ST170 “YES”), the optical axis adjustment amount calculating unit 130 acquires the optical axis adjustment amount and the adjustment direction from the positional relationship between the light shielding region and the irradiation region, and the irradiation target.

The optical axis adjustment direction is one of right and left directions in which the irradiation region closest to the irradiation target is such a region as to irradiate the irradiation target.

The optical axis adjustment amount is an adjustment angle necessary for the irradiation target to be included in the irradiation region when the optical axis is adjusted in the determined direction.

Then, the optical axis adjustment amount calculating unit 130 outputs the acquired optical axis adjustment amount and adjustment direction to the light distribution control unit 140.

Next, the light distribution control unit 140 generates and outputs a control signal (step ST190).

Specifically, the light distribution control unit 140 generates the control signal on the basis of the light shielding LED number acquired from the light shielding region determining unit 120 and the optical axis adjustment amount and the adjustment direction acquired from the optical axis adjustment amount calculating unit 130.

More specifically, the light shielding LED number is converted as a control signal indicating either turning-on or turning-off for each LED module 30 in the high beam unit 20 of the headlight 10. Further, the optical axis adjustment amount and the adjustment direction are converted as a control signal indicating how much the optical axis of the high beam unit 20 of the headlight 10 is inclined in which direction.

Then, the light distribution control unit 140 outputs the generated control signal to the headlight 10.

When the process of step ST190 ends, the light distribution control processing ends.

Hereinafter, a first processing example, a second processing example, and a third processing example will be described for an example of processing of determining whether an irradiation target is present in the light shielding region in step ST170.

The first processing example will be described.

The determination in step ST170 may be the first processing example of determination depending on an area in which the irradiation target is included in the light shielding region. This is because even if the entire irradiation target is not irradiated, it is conceivable that the user can visually recognize the irradiation target when the light-shielded area is small.

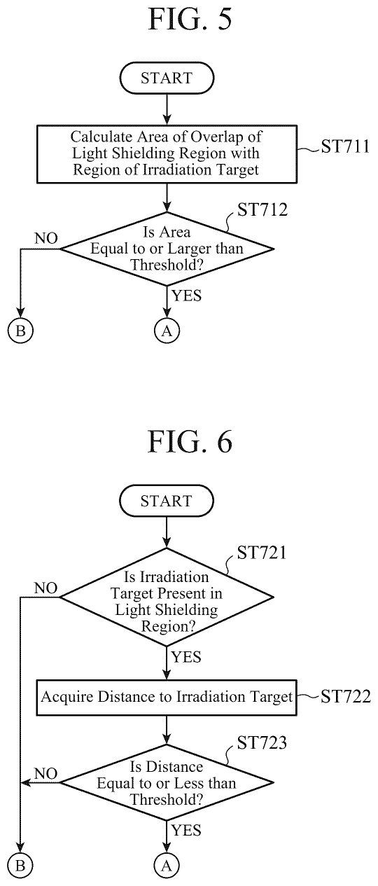

FIG. 5 is a flowchart illustrating an example of processing (first processing example) in step ST170 of FIG. 4.

The first processing example is processing of determining whether or not to adjust the optical axis depending on the degree of an area in which the irradiation target is included in the light shielding region. This processing is processing based on the viewpoint that the optical axis need not be changed in a case where the region where the irradiation target is shielded from light is small.

When the light distribution control device 100 starts the light distribution control processing and executes the processing from step ST110 to step ST160 illustrated in FIG. 4, next, the optical axis adjustment amount calculating unit 130 calculates an area of an overlap of the light shielding region with the region of the irradiation target (step ST711).

Specifically, in a case where the region where the irradiation target is present when the host vehicle is viewed as a reference overlaps with the light shielding region, the optical axis adjustment amount calculating unit 130 calculates the area of the overlapping portion.

The optical axis adjustment amount calculating unit 130 compares the calculated area with a threshold, and determines whether the area is equal to or more than the threshold (step ST712). Thus, it is possible to determine whether the degree to which the irradiation target is included in the light shielding region is equal to or more than a predetermined threshold.

When the optical axis adjustment amount calculating unit 130 determines that the area is equal to or more than the threshold (step ST712 “YES”), the light distribution control processing proceeds to the process of step ST180 of FIG. 4.

When the optical axis adjustment amount calculating unit 130 determines that the area is less than the threshold (step ST712 “NO”), the light distribution control processing proceeds to the process of step ST190 of FIG. 4.

Here, the description has been given using the area of the overlapping portion with the light shielding region, but a ratio of the area of the overlapping portion to the area of the entire irradiation target may be used.

The second processing example will be described.

The determination in step ST170 may be the second processing example using the distance from the host vehicle to the irradiation target. The second processing example is processing of determining whether or not to adjust the optical axis depending on the distance from the host vehicle to the irradiation target. This is because, when the distance to the irradiation target is long, it is conceivable that there is no problem in driving even when the user cannot visually recognize the irradiation target.

FIG. 6 is a flowchart illustrating an example of processing (second processing example) in step ST170 of FIG. 4.

When the light distribution control device 100 starts the light distribution control processing and executes the processing from step ST110 to step ST160 illustrated in FIG. 4, next, the optical axis adjustment amount calculating unit 130 determines whether the irradiation target is present in the light shielding region (step ST721).

Specifically, processing similar to that in step ST170 in FIG. 4 described above is performed.

When the optical axis adjustment amount calculating unit 130 determines that no irradiation target is present in the light shielding region (step ST721 “NO”), the light distribution control processing proceeds to the process of step ST190 of FIG. 4.

When the optical axis adjustment amount calculating unit 130 determines that the irradiation target is present in the light shielding region (step ST721 “YES”), the distance to the irradiation target is acquired (step ST722).

Specifically, for example, the optical axis adjustment amount calculating unit 130 acquires the distance to the irradiation target from the positional relationship between the host vehicle and the irradiation target included in the irradiation target information.

Next, the optical axis adjustment amount calculating unit 130 determines whether the distance is equal to or less than a threshold (step ST723).

When the optical axis adjustment amount calculating unit 130 determines that the distance is not equal to or less than the threshold (step ST723 “NO”), the light distribution control processing proceeds to the process of step ST190 of FIG. 4.

When the optical axis adjustment amount calculating unit 130 determines that the distance is equal to or less than the threshold (step ST723 “YES”), the light distribution control processing proceeds to the process of step ST180 of FIG. 4.

The third processing example will be described.

The determination in step ST170 may be the third processing example using the expected arrival time from the host vehicle to the irradiation target. The third processing example is processing of determining whether or not to adjust the optical axis depending on the expected arrival time until the host vehicle reaches the irradiation target. This is because when the expected arrival time to the irradiation target is long, it is conceivable that there is no problem in driving even when the user cannot visually recognize the irradiation target. In the following description, the expected arrival time is also simply referred to as an arrival time.

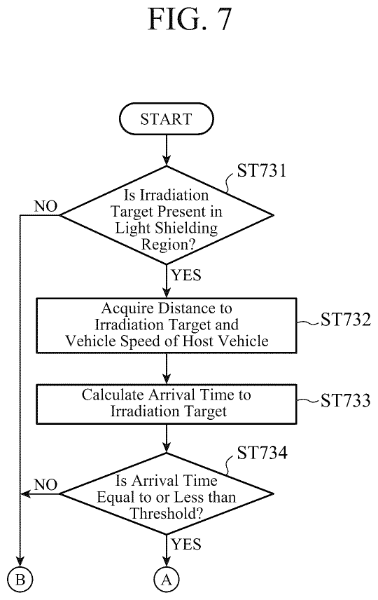

FIG. 7 is a flowchart illustrating an example of processing (third processing example) in step ST170 of FIG. 4.

When the light distribution control device 100 starts the light distribution control processing and executes the processing from step ST110 to step ST160 illustrated in FIG. 4, next, the optical axis adjustment amount calculating unit 130 determines whether the irradiation target is present in the light shielding region (step ST731).

Specifically, processing similar to that in step ST170 in FIG. 4 described above is performed.

When the optical axis adjustment amount calculating unit 130 determines that no irradiation target is present in the light shielding region (step ST731 “NO”), the light distribution control processing proceeds to the process of step ST190 of FIG. 4.

When the optical axis adjustment amount calculating unit 130 determines that the irradiation target is present in the light shielding region (step ST731 “YES”), the distance to the irradiation target and the vehicle speed of the host vehicle are acquired (step ST732). Specifically, for example, the distance to the irradiation target is acquired from the positional relationship between the host vehicle and the irradiation target included in the irradiation target information. At the same time, the vehicle speed of the host vehicle is acquired.

Next, the optical axis adjustment amount calculating unit 130 calculates an arrival time (expected arrival time) to the irradiation target (step ST733). Specifically, the optical axis adjustment amount calculating unit 130 calculates the arrival time to the irradiation target on the basis of the distance to the irradiation target and the vehicle speed of the host vehicle. The arrival time is obtained by dividing the distance to the irradiation target by the vehicle speed.

Next, the optical axis adjustment amount calculating unit 130 compares the arrival time with a threshold, and determines whether the arrival time is equal to or less than the threshold (step ST734).

When the optical axis adjustment amount calculating unit 130 determines that the arrival time is not equal to or less than the threshold (step ST734 “NO”), the light distribution control processing proceeds to the process of step ST190 of FIG. 4.

When the optical axis adjustment amount calculating unit 130 determines that the arrival time is equal to or less than the threshold (step ST734 “YES”), the light distribution control processing proceeds to the process of step ST180 of FIG. 4.

A concept of the light distribution control processing will be described.

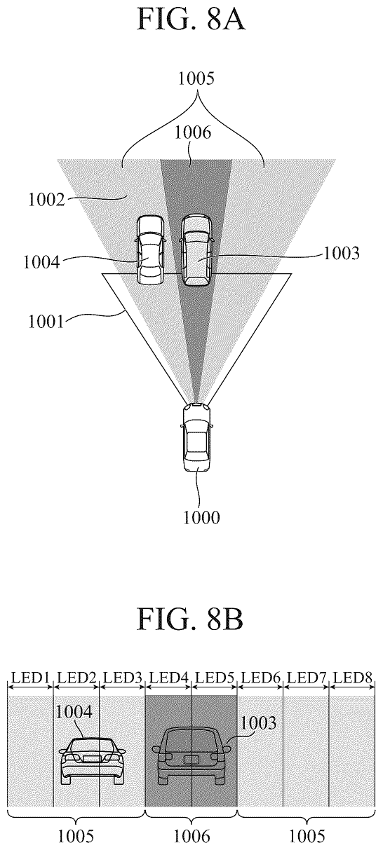

FIGS. 8A and 8B are diagrams illustrating an example in which it is determined in step 170 of the light distribution control processing that the irradiation target is not present in the light shielding region.

FIG. 8A is an overhead view.

FIG. 8B is a diagram illustrating how the high beam irradiation area overlaps with the light shielding target and the irradiation target when looking forward from the host vehicle 1000 side.

In FIG. 8B, the high beam unit 20 emits a high beam 1002 by eight LED modules 30, and emits light to eight high beam irradiation areas.

The numbers (LED numbers) of the LED modules 30 are numbered sequentially from the left, such as LED 1, LED 2, LED 3, LED 4, LED 5, LED 6, LED 7, and LED 8. The LEDs 1 to 8 irradiate different regions (high beam irradiation areas) with the high beam 1002. That is, the LED numbers (LED 1 to LED 8) are numbers corresponding to different high beam irradiation areas.

As illustrated in FIG. 8B, the LED 4 and the LED 5 in which a preceding vehicle that is a light shielding target is present are turned off to prevent glare of a driver of the preceding vehicle.

Then, when the LEDs 4 and 5 are turned off, a region that is not illuminated with the high beam is a light shielding region 1006, and a region illuminated with the high beam is an irradiation region 1005.

In the example illustrated in FIG. 8, since the irradiation target is present only in the regions of the LEDs 2 and 3 and is not in the light shielding region 1006, the light distribution control processing proceeds to step ST190, and the control signal is generated in the same state.

In this manner, a region where no other vehicle is present is irradiated with a high beam to maintain visibility, and a region where another vehicle is present is not irradiated with a high beam, and glare to a driver of another vehicle can be prevented.

Here, on a road on which the host vehicle 1000 is traveling, there may be present both an object that should not be irradiated (hereinafter, a light shielding target 1003) such as a preceding vehicle and an object that should originally be irradiated (hereinafter, an irradiation target 1004) such as an obstacle.

At this time, by turning off the LED module 30 in the region where the light shielding target 1003 is present, the irradiation target 1004 may be included in the light shielding region 1006.

Thus, the irradiation target 1004 is not irradiated with the high beam 1002, the visibility is deteriorated, and finding by the user may be delayed.

In this case, according to the present disclosure, the light distribution control processing is executed as follows.

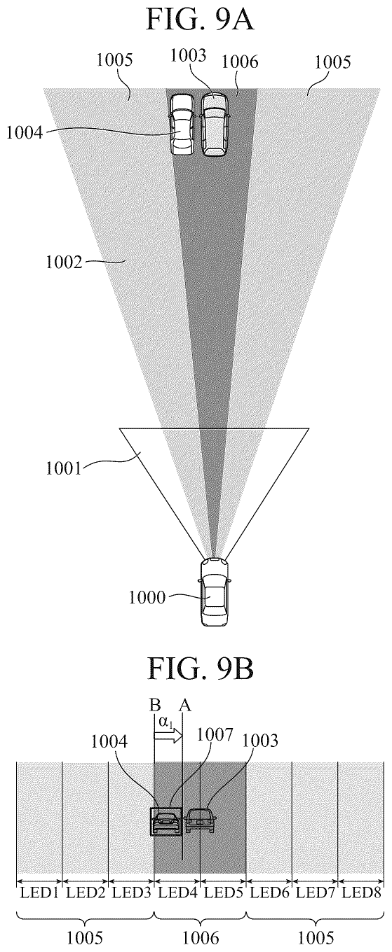

FIGS. 9A and 9B are diagrams illustrating an example in which it is determined in step 170 of the light distribution control processing that the irradiation target 1004 is in the light shielding region 1006.

FIG. 9A is an overhead view.

FIG. 9B is a diagram illustrating how the light shielding region 1006 overlaps with the light shielding target 1003 and the irradiation target 1004 in the high beam irradiation area when looking forward from the host vehicle 1000 side.

In FIG. 9B, the high beam unit 20 irradiates eight high beam irradiation areas with light by eight LED modules 30 as in FIG. 8B.

As illustrated in FIG. 9B, the LED 4 and the LED 5 in which the preceding vehicle that is the light shielding target 1003 is present are turned off to prevent glare of the driver of the preceding vehicle.

Then, a region that is not illuminated by the high beam 1002 when the LED 4 and the LED 5 are turned off is the light shielding region 1006.

Thus, the vehicle stopped with no lights on that should be irradiated is not illuminated with the high beam, so that the light distribution control processing according to the present disclosure proceeds to step ST180 to adjust the optical axis.

In FIG. 9, the irradiation region closest to the vehicle stopped with no lights on (irradiation target 1004) is a region irradiated by the LED 3.

Thus, the optical axis is only required to be adjusted in such a manner that the LED 3 irradiates the vehicle stopped with no lights on (irradiation target 1004).

The irradiation region 1005 of the LED 3 is located on the left side of the vehicle stopped with no lights on (irradiation target 1004), and thus the adjustment direction of the optical axis is the right direction (arrow α₁).

The optical axis adjustment amount (arrow α₁) is an amount of movement of the optical axis of the high beam unit 20 necessary for causing the line B, which is the boundary line between the light shielding region 1006 and the irradiation region 1005 (the boundary line between the LED 3 and the LED 4), to overlap with the line A, which is the right end of the vehicle stopped with no lights on (irradiation target 1004).

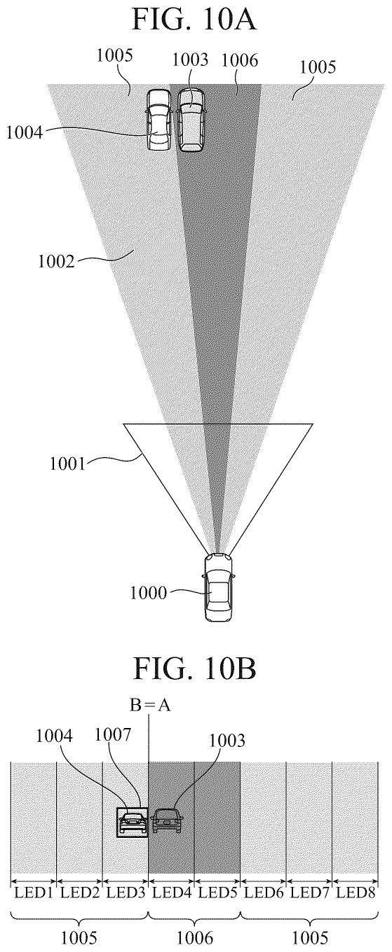

FIGS. 10A and 10B are diagrams illustrating a state after the optical axis is adjusted by the light distribution control processing.

FIG. 10A is an overhead view.

FIG. 10B is a diagram illustrating how the high beam irradiation area (the irradiation region and the light shielding region) overlaps with the light shielding target 1003 and the irradiation target 1004 when looking forward from the host vehicle 1000 side.

As illustrated in FIGS. 10A and 10B, by moving the optical axis of the high beam unit 20 depending on the optical axis adjustment amount and the adjustment direction determined in step ST180, a region 1007 where the vehicle stopped with no lights on (irradiation target 1004) is located is out of the light shielding region 1006 and is in the irradiation region 1005, and the user can easily visually recognize the vehicle stopped with no lights on (irradiation target 1004).

With the configuration and the processing described in the first embodiment, even in a case where an object to be irradiated and an object to be shielded are included in the light shielding region, it is possible to appropriately irradiate or shield the light depending on the object.

Note that, if the number of divisions of the LED is increased, the light shielding region can be subdivided, and the problem as described above hardly occurs, but the cost increases accordingly.

The light distribution control device 100 according to the present disclosure can obtain the above-described effect without increasing the number of divisions of the LED.

A light distribution control device according to the present disclosure is a light distribution control device that controls a high beam unit capable of dividing a high beam irradiation area into a plurality of areas, the light distribution control device being configured to include an object detecting unit to detect whether or not an irradiation target to be irradiated with a high beam or a light shielding target to be shielded from the high beam is present in the high beam irradiation area, a light shielding region determining unit to determine a light shielding region for shielding the light shielding target when the object detecting unit detects the light shielding target, an optical axis adjustment amount calculating unit to calculate an optical axis adjustment amount for adjusting a direction of an optical axis of the high beam unit in such a manner that the irradiation target is out of the light shielding region when the irradiation target is included in the light shielding region, and a light distribution control unit to control the optical axis of the high beam unit on the basis of the optical axis adjustment amount.

Thus, there is an effect that it is possible to provide a light distribution control device capable of irradiating an irradiation target with a high beam when the irradiation target is present together with a light shielding target in each high beam irradiation area of a plurality of high beam irradiation areas.

A headlight device according to the present disclosure is configured to include a high beam unit capable of dividing a high beam irradiation area into a plurality of areas, an object detecting unit to detect whether or not an irradiation target to be irradiated with a high beam or a light shielding target to be shielded from the high beam is present in the high beam irradiation area, a light shielding region determining unit to determine a light shielding region for shielding the light shielding target when the object detecting unit detects the light shielding target, an optical axis adjustment amount calculating unit to calculate an optical axis adjustment amount for adjusting a direction of an optical axis of the high beam unit in such a manner that the irradiation target is out of the light shielding region when the irradiation target is included in the light shielding region, and a light distribution control unit to control the optical axis of the high beam unit on the basis of the optical axis adjustment amount.

Thus, there is an effect that it is possible to provide a headlight device capable of irradiating an irradiation target with a high beam when the irradiation target is present together with a light shielding target in each high beam irradiation area of a plurality of high beam irradiation areas.

A light distribution control method according to the present disclosure is a light distribution control method for controlling a high beam unit capable of dividing a high beam irradiation area into a plurality of areas, the light distribution control method including an object detecting step of detecting, by an object detecting unit, whether or not an irradiation target to be irradiated with a high beam or a light shielding target to be shielded from the high beam is present in the high beam irradiation area, a light shielding region determining step of determining, by a light shielding region determining unit, a light shielding region for shielding the light shielding target when the object detecting unit detects the light shielding target, an optical axis adjustment amount calculating step of calculating, by an optical axis adjustment amount calculating unit, an optical axis adjustment amount for adjusting a direction of an optical axis of the high beam unit in such a manner that the irradiation target is out of the light shielding region when the irradiation target is included in the light shielding region, and a light distribution control step of controlling, by a light distribution control unit, the optical axis of the high beam unit on the basis of the optical axis adjustment amount.

Thus, there is an effect that it is possible to provide a light distribution control method capable of irradiating an irradiation target with a high beam when the irradiation target is present together with a light shielding target in each high beam irradiation area of a plurality of high beam irradiation areas.

In the light distribution control device according to the present disclosure, the optical axis adjustment amount calculating unit is configured to calculate a degree to which the irradiation target is included in the light shielding region, and calculate the optical axis adjustment amount when the degree is equal to or more than a predetermined threshold.

Thus, it is possible to provide the light distribution control device that does not adjust the optical axis when most of an irradiation target to be irradiated with a high beam is irradiated with the high beam and adjusts the optical axis when most of the irradiation target to be originally irradiated with the high beam is included in the light shielding region.

As a result, even when the irradiation target to be irradiated with the high beam is included in the light shielding region and is difficult for the driver to recognize, the irradiation target can be irradiated with the high beam.

In addition, when the above configuration is applied to a headlight device or a light distribution control method, it is possible to achieve a headlight device and a light distribution control method that produce effects similar to those described above.

In the light distribution control device according to the present disclosure, the optical axis adjustment amount calculating unit is configured to calculate the optical axis adjustment amount when the irradiation target is included in the light shielding region and a distance between a vehicle on which the high beam unit is mounted and the irradiation target is equal to or less than a predetermined distance.

Thus, there is an effect that it is possible to provide a light distribution control device that does not adjust the optical axis when the distance between the host vehicle and the irradiation target is too long.

In addition, when the above configuration is applied to a headlight device or a light distribution control method, it is possible to achieve a headlight device and a light distribution control method that produce effects similar to those described above.

In the light distribution control device according to the present disclosure, the optical axis adjustment amount calculating unit is configured to calculate the optical axis adjustment amount when an expected arrival time until a vehicle on which the high beam unit is mounted reaches the irradiation target is equal to or less than a predetermined arrival time threshold.

Thus, there is an effect that it is possible to provide a light distribution control device that does not adjust the optical axis when it takes time for the host vehicle to reach the irradiation target.

In addition, when the above configuration is applied to a headlight device or a light distribution control method, it is possible to achieve a headlight device and a light distribution control method that produce effects similar to those described above.

### Second Embodiment

In a second embodiment, a mode in which the light shielding region is adjusted again after the optical axis is adjusted will be described. This is a mode considering that the irradiation range is widened by optical axis adjustment.

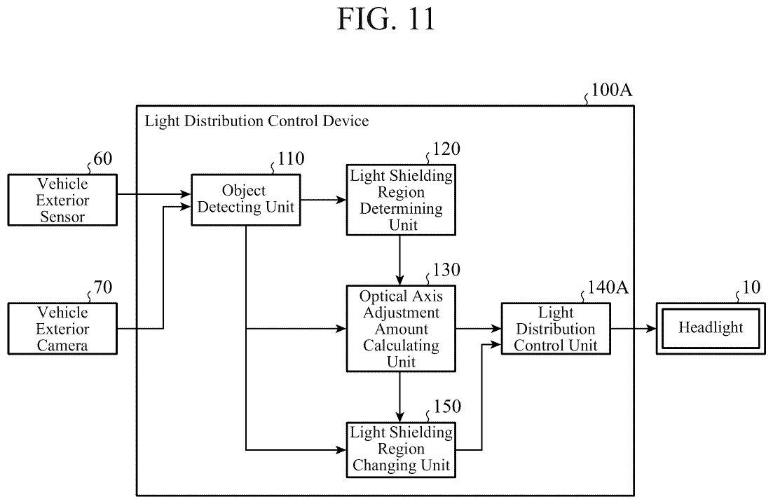

FIG. 11 is a diagram illustrating a configuration example of a light distribution control device 100A according to the second embodiment.

In FIG. 11, the configuration described in the first embodiment is denoted by the same reference numeral, and the description thereof is appropriately omitted here. Specifically, the object detecting unit 110 illustrated in FIG. 11 is similar to the object detecting unit 110 described above except that the irradiation target information and the light shielding target information are output to a light shielding region changing unit 150. The light shielding region determining unit 120 illustrated in FIG. 11 is similar to the light shielding region determining unit 120 described above, and the optical axis adjustment amount calculating unit 130 illustrated in FIG. 11 is similar to the optical axis adjustment amount calculating unit 130 described above.

The light distribution control device 100A illustrated in FIG. 11 includes a light distribution control unit 140A.

The light distribution control device 100A illustrated in FIG. 11 further includes the light shielding region changing unit 150.

The light shielding region changing unit 150 adjusts the light shielding region determined by the light shielding region determining unit 120 in consideration of the state in which the light distribution control unit 140A has adjusted the optical axis.

Specifically, the light shielding region changing unit 150 acquires the irradiation target information and light shielding target information from the object detecting unit 110. Further, the optical axis adjustment amount and the adjustment direction are acquired from the optical axis adjustment amount calculating unit 130. The light shielding region changing unit 150 changes the light shielding region on the basis of the positional relationship between the host vehicle and the irradiation target and the light shielding target, and the optical axis adjustment amount and the adjustment direction.

The timing at which the light shielding region changing unit 150 adjusts the light shielding region may be before or after the optical axis is adjusted by the light distribution control unit 140A.

The light distribution control unit 140A further controls the light distribution by the high beam unit 20 in such a manner as to change to the light shielding region adjusted by the light shielding region changing unit 150.

Specifically, the light distribution control unit 140A acquires the light shielding LED number from the light shielding region changing unit 150. When acquiring the light shielding LED number from the light shielding region changing unit 150, the light distribution control unit 140A commands the LED module 30 corresponding to the light shielding LED number to change from the light-on state to the light-off state.

For the processing according to the second embodiment, the description of the processing described in the first embodiment will be omitted as appropriate, and processing not described in the first embodiment will be described.

In the second embodiment, in step ST180 of FIG. 4, the optical axis adjustment amount and the adjustment direction are determined, and then the light shielding region is changed again.

An example of this detailed processing will be described.

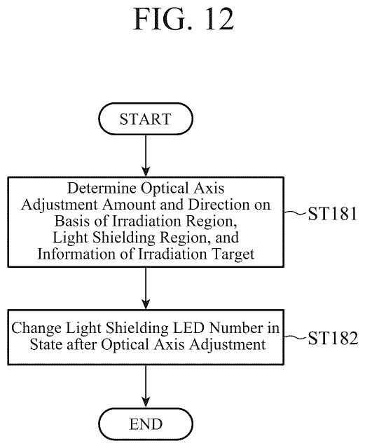

FIG. 12 is a flowchart illustrating an example of the light distribution control processing by the light distribution control device 100A according to the second embodiment.

When the processing of step ST180 is started in the arrangement control processing, the optical axis adjustment amount calculating unit 130 determines the optical axis adjustment amount and the adjustment direction on the basis of the irradiation region, the light shielding region, and the irradiation target information (step ST181).

Specifically, as in the first embodiment, the optical axis adjustment amount calculating unit 130 determines the optical axis adjustment amount and the adjustment direction from the positional relationship between the light shielding region and the irradiation region, and the irradiation target. The optical axis adjustment amount calculating unit 130 outputs the determined optical axis adjustment amount and adjustment direction to the light shielding region changing unit 150 and the light distribution control unit 140A.

The light shielding region changing unit 150 changes the light shielding LED number in the state after the optical axis adjustment (step ST182).

In step ST182, the light shielding region changing unit 150 changes the light shielding LED number on the basis of the light shielding target information acquired from the object detecting unit 110, and the optical axis adjustment amount and the adjustment direction.

Specifically, the light shielding region changing unit 150 determines the light shielding LED number again on the basis of the irradiation region of each LED module 30 after changing the optical axis of the high beam unit 20 in the optical axis adjustment amount and the adjustment direction and the light shielding target information.

More specifically, the light shielding region changing unit 150 compares the irradiation region of each LED module 30 after changing the optical axis with the region where the light shielding target is present (the region that can be acquired from the position and size of the light shielding target included in the light shielding target information), and determines the LED number of the LED module 30 corresponding to the region where they overlap as the light shielding LED number.

The light shielding region changing unit 150 outputs the changed light shielding LED number to the light distribution control unit 140A.

A concept of processing of the second embodiment will be described.

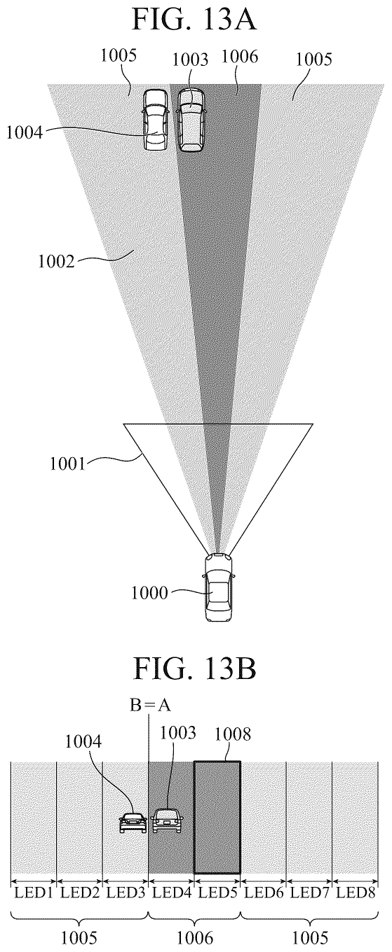

FIGS. 13A and 13B are diagrams illustrating a state after the optical axis is adjusted by the light distribution control processing according to the first embodiment.

FIG. 13A is an overhead view.

FIG. 13B is a diagram illustrating how the high beam irradiation area (the irradiation region 1005 and the light shielding region 1006) overlaps with the light shielding target 1003 and the irradiation target 1004 when looking forward from the host vehicle 1000 side.

FIG. 13 illustrates the same state as the state illustrated in FIG. 10, and is a state in which the optical axis adjustment amount and the adjustment direction are acquired on the basis of the positional relationship between the light shielding target 1003 and the irradiation target 1004, and the optical axis is changed. Due to the optical axis change, an irradiation region 1008 of the LED 5 is out of the area where the preceding vehicle that is the light shielding target 1003 is present. Thus, in step ST182, only the “LED 4” is selected as the light shielding LED number after the change.

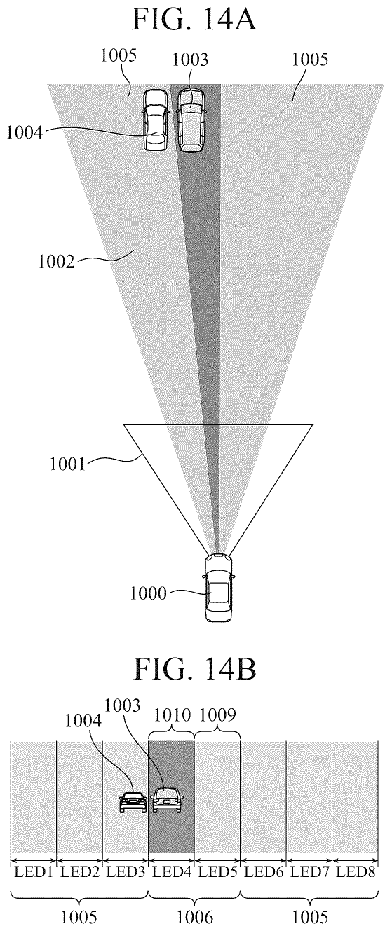

FIGS. 14A and 14B are diagrams for describing a concept of light distribution control processing according to the second embodiment.

FIG. 14A is an overhead view.

FIG. 14B is a diagram illustrating how the high beam irradiation area (the irradiation region 1005 and the light shielding region 1006) overlaps with the light shielding target 1003 and the irradiation target 1004 when looking forward from the host vehicle 1000 side.

FIG. 14 illustrates a state after the light shielding region 1006 is changed from the state illustrated in FIG. 13 by the above-described processing. When the LED 5 is out of the light shielding LED number, a region 1009 corresponding to the LED 5 is irradiated. Further, the light shielding region 1006 is only a region 1010 corresponding to the LED 4.

With the configuration and the processing described in the second embodiment, the light shielding region can be further appropriately determined even after the optical axis is adjusted.

The light distribution control device according to the present disclosure is configured to further include a light shielding region changing unit to adjust the light shielding region determined by the light shielding region determining unit in consideration of a state in which the light distribution control unit has adjusted the optical axis.

Thus, there is an effect that it is possible to provide a light distribution control device that appropriately adjusts an irradiation region and a light shielding region depending on a state after an optical axis is adjusted.

In addition, when the above configuration is applied to a headlight device or a light distribution control method, it is possible to achieve a headlight device and a light distribution control method that produce effects similar to those described above.

### Third Embodiment

In a third embodiment, a mode for selecting an irradiation target to be irradiated preferentially will be described.

This mode is a mode from the viewpoint that an object located in the host vehicle lane or closer to the host vehicle lane is related more to driving operation, and thus it is desirable that the object can be found earlier and it is necessary to irradiate the object preferentially.

In the third embodiment, the configurations already described are denoted by the same reference numerals, and the description thereof will be omitted as appropriate.

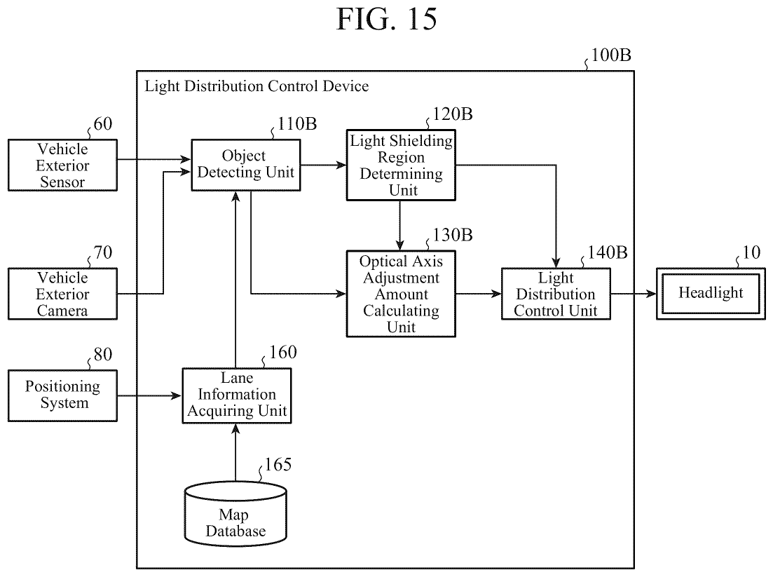

FIG. 15 is a diagram illustrating a configuration example of a light distribution control device 100B according to the third embodiment.

The light distribution control device 100B is further connected to a positioning system 80.

The light distribution control device 100B includes an object detecting unit 110B, a light shielding region determining unit 120B, an optical axis adjustment amount calculating unit 130B, a light distribution control unit 140B, a lane information acquiring unit 160, and a map database 165.

The light shielding region determining unit 120B, the optical axis adjustment amount calculating unit 130B, and the light distribution control unit 140B are similar to the light shielding region determining unit 120, the optical axis adjustment amount calculating unit 130, and the light distribution control unit 140 that have already been described, and thus detailed description thereof will be omitted.

The positioning system 80 is, for example, a global positioning system (GPS), and can acquire position information (latitude, longitude, altitude) of the host vehicle.

The map database 165 is a database that stores map information including lane information of roads.

The positioning system 80 and the map database 165 may be different from the light distribution control device and may be mounted on the same system, like a car navigation system that guides the user.

The lane information acquiring unit 160 acquires lane information indicating a traveling lane of the vehicle.

The lane information acquiring unit 160 acquires lane information using the map information acquired from the map database 165 and the position information of the host vehicle acquired from the positioning system 80.

The lane information is a position of a lane in which the host vehicle is traveling.

For example, the object detecting unit 110B selects one of a plurality of irradiation targets with priority given to an object in the host vehicle lane that is the lane in which the host vehicle is traveling.

Further, for example, in a case where there is a plurality of objects in the host vehicle lane, the object detecting unit 110B selects one of the plurality of irradiation targets with priority given to an object at a shorter distance among the objects.

Furthermore, for example, when none of the plurality of irradiation targets is in the host vehicle lane, the object detecting unit 110B selects one of the plurality of irradiation targets with priority given to an object at a shorter distance from the host vehicle lane.

Specifically, the object detecting unit 110B discriminates a light shielding target and an irradiation target, and acquires respective pieces of information (position, size, and the like).

When a plurality of irradiation targets is present, the object detecting unit 110B selects one irradiation target on the basis of the lane information. Specifically, the object detecting unit 110B determines the irradiation target most related to the host vehicle lane by comparing the position of the lane in which the host vehicle is traveling with the positions of all the irradiation targets.

The object detecting unit 110B outputs the irradiation target information regarding the determined irradiation target.

Here, the most related irradiation target is the closest irradiation target among those being present in the host vehicle lane.

Further, when none of them is present in the host vehicle lane, it is the irradiation target present closest to the host vehicle lane.

The reason why the object in the host vehicle lane or the object near the host vehicle lane is set as an irradiation target is that there is a high possibility that these objects are in the trajectory in which the host vehicle travels, and these objects should be irradiated preferentially.

Processing according to the third embodiment will be described.

In the processing according to the third embodiment, the description of the processing that has already been described is appropriately omitted, and processing that has not been described so far will be described.

In the third embodiment, in step ST170 of FIG. 4, in a case where a plurality of irradiation targets is present, the irradiation targets are selected depending on the lane position in which the host vehicle travels and respective positions of the irradiation targets.

An example of this detailed processing will be described.

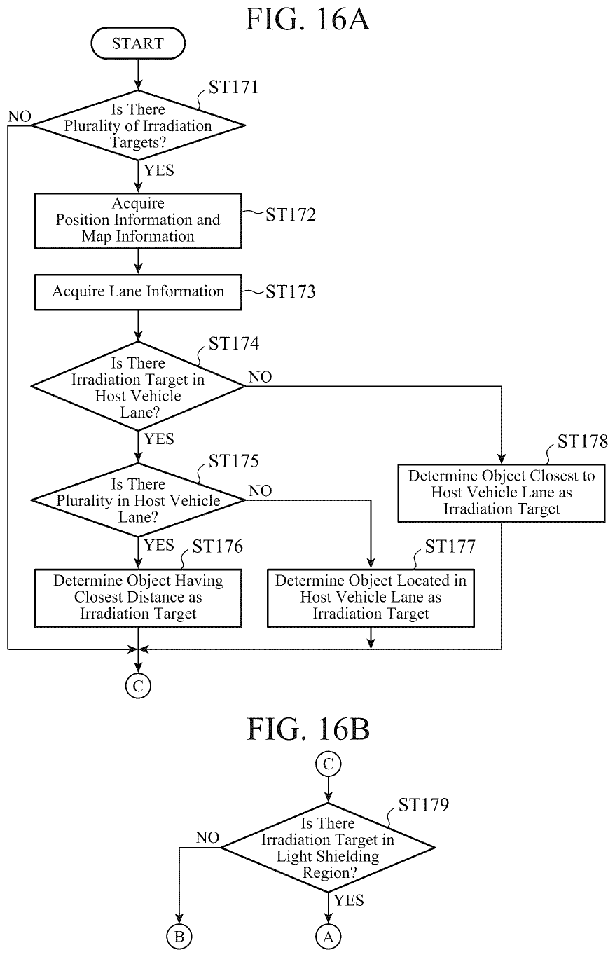

FIGS. 16A and 16B are flowcharts illustrating an example of the light distribution control processing by the light distribution control device 100B according to the third embodiment.

First, the object detecting unit 110B determines whether there is a plurality of irradiation targets (step ST171).

Specifically, the object detecting unit 110B acquires the number of irradiation targets and determines whether a plurality of irradiation targets is present.

When the object detecting unit 110B determines that there is one or less irradiation targets (step ST171 “NO”), the processing proceeds to step ST179.

When the object detecting unit 110B determines that a plurality of irradiation targets is present (step ST171 “YES”), the lane information acquiring unit 160 acquires position information and map information of the host vehicle (step ST172).

Specifically, the lane information acquiring unit 160 acquires position information of the host vehicle from the positioning system 80 and acquires map information from the map database 165.

Next, the lane information acquiring unit 160 acquires lane information (step ST173).

Specifically, the lane information acquiring unit 160 acquires lane information in which the host vehicle is traveling on the basis of the position information of the host vehicle and the map information.

More specifically, lane information of a road at a point corresponding to latitude, longitude, and altitude included in the position information of the host vehicle is acquired from the map information. Then, the lane information acquiring unit 160 outputs lane information in which the host vehicle is traveling to the object detecting unit 110B.

Next, the object detecting unit 110B determines whether there is an irradiation target in the host vehicle lane (step ST174).

Specifically, the object detecting unit 110B acquires lane information in which the host vehicle is traveling from the lane information acquiring unit 160, compares the lane information in which the host vehicle is traveling with the positions of all the irradiation targets detected by the object detecting unit 110B, and determines whether there is an irradiation target in the host vehicle lane.

More specifically, the object detecting unit 110B compares a range of the lane in which the host vehicle is traveling in the traveling direction of the host vehicle with position information of an irradiation target, and determines that the irradiation target is in the host vehicle lane when the range of the lane and a part or all of the irradiation target overlap. The object detecting unit 110B performs similar processing on all the irradiation targets.

When the object detecting unit 110B determines that there is an irradiation target in the host vehicle lane (step ST174 “YES”), the object detecting unit 110B further determines whether there is a plurality of irradiation targets in the host vehicle lane (step ST175).

Specifically, when there is one or more irradiation targets determined to be present in the host vehicle lane, the object detecting unit 110B further acquires the number of irradiation targets determined to be present in the host vehicle lane, and determines whether a plurality of irradiation targets is present.

When the object detecting unit 110B determines that there is a plurality of irradiation targets in the host vehicle lane (step ST175 “YES”), the object detecting unit 110B further determines one having the closest distance as an irradiation target (step ST176).

Specifically, when a plurality of irradiation targets is present in the host vehicle lane, the object detecting unit 110B acquires a distance from the host vehicle included in the irradiation target information for each of the irradiation targets determined to be in the host vehicle lane, and determines one having the closest distance as an irradiation target.

When it is determined that there is not a plurality of irradiation targets in the host vehicle lane (step ST175 “NO”), the object detecting unit 110B determines one located in the host vehicle lane as an irradiation target (step ST177).

When the object detecting unit 110B determines that there is no irradiation target in the host vehicle lane (step ST174 “NO”), the object detecting unit 110B determines one closest to the host vehicle lane as an irradiation target (step ST178). Specifically, the object detecting unit 10B acquires a horizontal distance between the host vehicle lane and the irradiation target at the position of the irradiation target for each of the irradiation targets detected by the object detecting unit 110B, and determines the closest one as an irradiation target.

After the processing of step ST171 “NO”, step ST176, step ST177, or step ST178, the object detecting unit 110B determines whether an irradiation target is present in the light shielding region (step ST179).

When the object detecting unit 110B determines that an irradiation target is present in the light shielding region (step ST179 “YES”), the processing proceeds to the process of step ST180 of FIG. 4B.

When the object detecting unit 110B determines that no irradiation target is present in the light shielding region (step ST179 “NO”), the processing proceeds to the process of step ST190 of FIG. 4C.

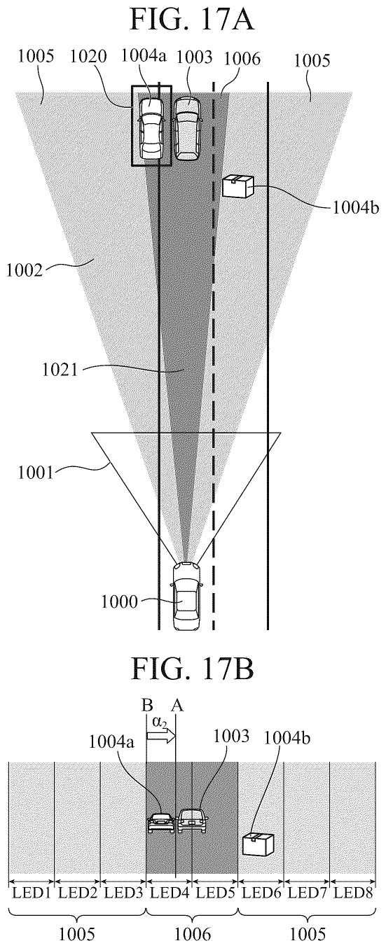

FIGS. 17A and 17B are diagrams illustrating an example of a situation when it is determined in step ST171 that there is a plurality of irradiation targets.

FIG. 17A is an overhead view.

FIG. 17B is a diagram illustrating how the high beam irradiation area (the irradiation region 1005 and the light shielding region 1006) overlaps with the light shielding target 1003 and the irradiation target 1004 when looking forward from the host vehicle 1000 side.

In the example of FIG. 17, there are two irradiation targets which are a vehicle stopped with no lights on (irradiation target 1004a) and a road fallen object (irradiation target 1004b). As illustrated in FIG. 17A, a part of the vehicle stopped with no lights on is overlapped in a lane in which the host vehicle 1000 is traveling (in a host vehicle lane 1021). In addition, the road fallen object (irradiation target 1004b) is present outside the host vehicle lane 1021. Thus, in this case, the vehicle stopped with no lights on (irradiation target 1004a) is selected as an irradiation target 1020.

In the example of FIG. 17, there is one object in the lane in which the host vehicle 1000 is traveling (in the host vehicle lane 1021) (step ST175 “NO”), and thus the vehicle stopped with no lights on (irradiation target 1004a) is selected as it is as an irradiation target (step ST177). If there are two or more irradiation targets in the lane in which the host vehicle 1000 is traveling (in the host vehicle lane 1021) (step ST175 “YES”), an object having the closest distance to the host vehicle is selected as an irradiation target (step ST176). If the irradiation target 1004b (fallen object on the road) illustrated in FIG. 17A is inside the host vehicle lane 1021 in which the host vehicle 1000 is traveling, one of the irradiation target 1004a and the irradiation target 1004b at a shorter distance from the host vehicle 1000 is selected as an irradiation target.

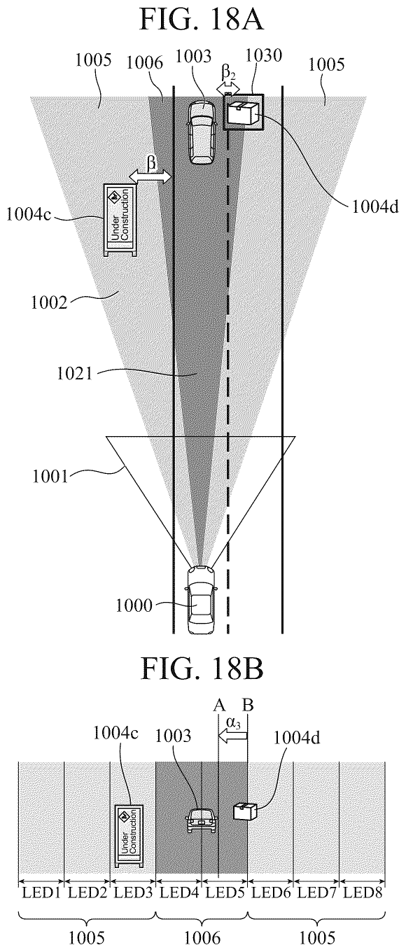

FIGS. 18A and 18B are diagrams illustrating a situation in which it is determined in step ST171 that there is a plurality of irradiation targets 1004 and it is further determined in step ST174 that there is no irradiation target 1004 in the host vehicle lane 1021 (step ST174 “NO”).

FIG. 18A is an overhead view.

FIG. 18B is a diagram illustrating how the high beam irradiation area (the irradiation region 1005 and the light shielding region 1006) overlaps with the light shielding target 1003 and the irradiation target 1004 when looking forward from the host vehicle 1000 side.

In the example of FIG. 18, there are two irradiation targets which are a road installed object 1004c and a road fallen object 1004d. As illustrated in FIG. 18A, when a distance β₁ between an object 1 (road installed object 1004c) and the lane and a distance β₂ between an object 2 (road fallen object 1004d) and the lane are compared, the distance β₂ is smaller. That is, the object 2 (road fallen object 1004d) is closer to the host vehicle lane. Thus, in this case, the object 2 (road fallen object 1004d) is selected as an irradiation target 1030.

With the configuration and the processing described in the third embodiment, for example, even when there is a plurality of irradiation targets, an object to be irradiated can be selected.

The light distribution control device according to the present disclosure is configured to further include a lane information acquiring unit to acquire lane information indicating a traveling lane of a vehicle on which the high beam unit is mounted, in which the object detecting unit selects an irradiation target on the basis of the lane information.

Thus, for example, there is an effect that it is possible to provide a light distribution control device that selects an irradiation target on the basis of the lane information in which the host vehicle is traveling even when there is a plurality of irradiation targets.

In addition, when the above configuration is applied to a headlight device or a light distribution control method, it is possible to achieve a headlight device and a light distribution control method that produce effects similar to those described above.

### Fourth Embodiment

In a fourth embodiment, a mode will be described in which, when the optical axis is adjusted, the optical axis adjustment amount is further reduced while the irradiation target is irradiated.

This mode is a mode considering the improvement of the processing efficiency by reducing the optical axis adjustment amount.

Since a light distribution control device according to the fourth embodiment has components similar to the components illustrated in FIG. 11, the same reference numerals will be used for description while omitting illustration, and description of contents already described will be omitted as appropriate.

The optical axis adjustment amount calculating unit 130 in the fourth embodiment further determines the optical axis adjustment amount and the adjustment direction in such a manner that the optical axis adjustment amount becomes smaller.

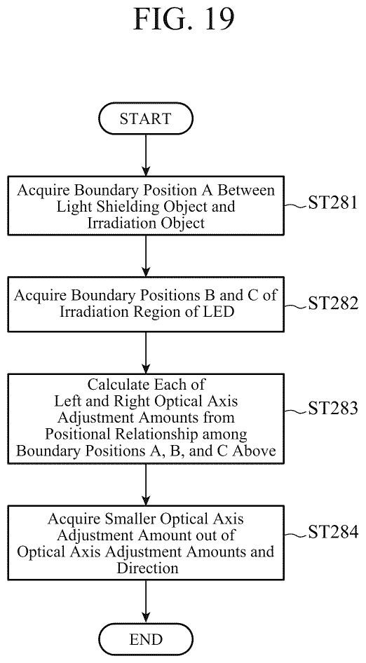

FIG. 19 is a flowchart illustrating an example of light distribution control processing by a light distribution control device 100C according to the fourth embodiment.

The process illustrated in FIG. 19 is an example of a more detailed process in the process of step ST181 illustrated in FIG. 12.

In the process illustrated in FIG. 19, the optical axis adjustment amount and the adjustment direction are acquired on the basis of a boundary position of a region irradiated by the LED module 30 in addition to a position of a light shielding target and a position of an irradiation target.

First, the optical axis adjustment amount calculating unit 130 acquires a boundary position A between the light shielding target and the irradiation target (step ST281).

Specifically, the optical axis adjustment amount calculating unit 130 acquires the boundary position A from the positional relationship between the irradiation target and the light shielding target. The boundary position A is a left-right center of a region between the light shielding target and the irradiation target, and is a position that exactly divides the light shielding target and the irradiation target.

Next, the optical axis adjustment amount calculating unit 130 acquires a boundary position B and a boundary position C of the irradiation region of the LED module 30 (step ST282).

The boundary position B and the boundary position C are closest boundary positions on the left and right of the irradiation target among boundaries of the irradiation regions of the LED modules 30.

Next, the optical axis adjustment amount calculating unit 130 calculates the left and right optical axis adjustment amounts from the positional relationship among the boundary position A, the boundary position B, and the boundary position C (step ST283).

Specifically, the optical axis adjustment amount calculating unit 130 calculates a change angle of the optical axis for causing the boundary position A and the boundary position B or the boundary position A and the boundary position C to overlap with each other.

Next, the optical axis adjustment amount calculating unit 130 acquires a smaller optical axis adjustment amount out of the optical axis adjustment amounts and the adjustment direction (step ST284).

Specifically, the optical axis adjustment amount calculating unit 130 selects a smaller optical axis adjustment amount from the left and right optical axis adjustment amounts, and acquires the optical axis adjustment amount and the adjustment direction.

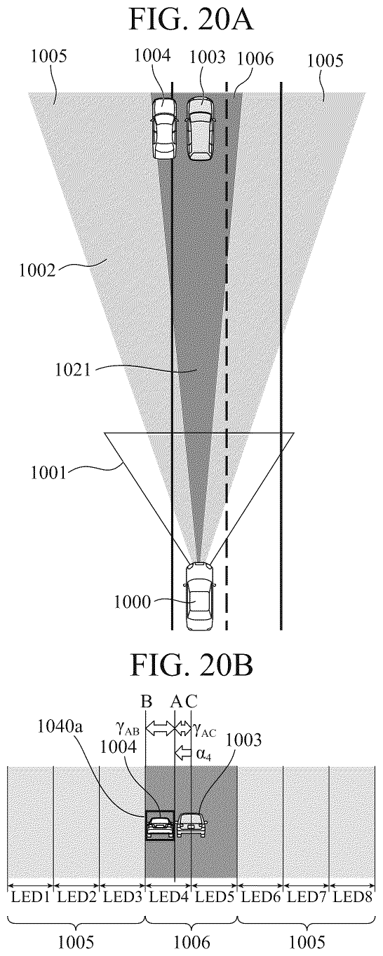

FIGS. 20A and 20B are diagrams illustrating an example in which it is determined in step 170 of the light distribution control processing that the irradiation target is present in the light shielding region (step ST170 “YES”).

FIG. 20A is an overhead view.

FIG. 20B is a diagram illustrating how the high beam irradiation area (the irradiation region 1005 and the light shielding region 1006) overlaps with the light shielding target 1003 and the irradiation target 1004 when looking forward from the host vehicle 1000 side.

In FIG. 20B, a region 1040a where an irradiation target 1004 is present is included in the light shielding region.

In the first embodiment described in FIG. 9, only the boundary position B between the LED 3 and the LED 4, which is the boundary between the light shielding region 1006 and the irradiation region 1005, is acquired. In addition, in the light distribution control processing of the fourth embodiment, as illustrated in FIG. 20B, the boundary position C between the LED 4 and the LED 5 included in the light shielding region is also acquired.

Then, in the light distribution control processing of the fourth embodiment, distances γ between the boundary position A and the boundary position B and between the boundary position A and the boundary position C are acquired, and the smaller one is selected. In FIG. 20, a distance γ_{AC} between the boundary position A and the boundary position C is smaller than a distance γ_{AB} between the boundary position A and the boundary position B, and thus the boundary position C is selected.

Then, in the light distribution control processing of the fourth embodiment, the optical axis adjustment amount and the adjustment direction are acquired from the positional relationship between the boundary position A and the boundary position C. In FIG. 20, the boundary position A is on the left side of the boundary position C, and thus the optical axis adjustment direction is the left direction. The optical axis adjustment amount is a change angle of the optical axis necessary for the boundary position C to overlap with the boundary position A.

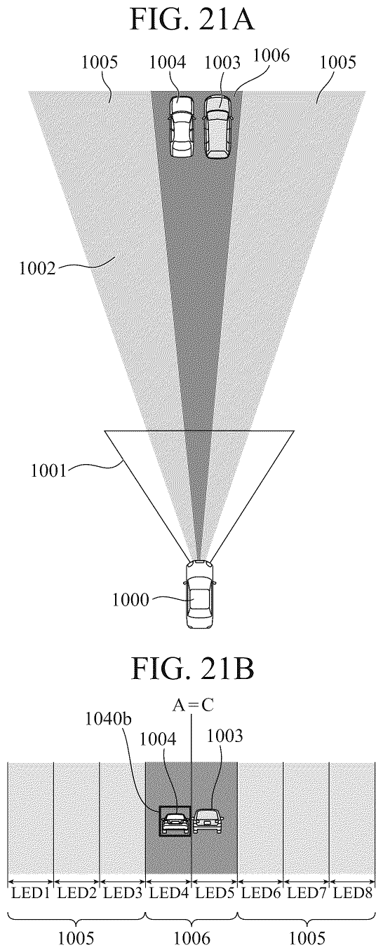

FIGS. 21A and 21B are diagrams illustrating a state after the optical axis is adjusted.

FIG. 21A is an overhead view.

FIG. 21B is a diagram illustrating how the high beam irradiation area (the irradiation region 1005 and the light shielding region 1006) overlaps with the light shielding target 1003 and the irradiation target 1004 when looking forward from the host vehicle 1000 side.

FIG. 21 is a diagram illustrating a state after the optical axis is adjusted from the state of FIG. 20.

The optical axis of the high beam unit 20 is moved on the basis of the optical axis adjustment amount and the adjustment direction determined in the processing from step ST281 to step ST284.

Here, in this state, a region 1040b where the irradiation target 1004 is present is in the light shielding region 1006, and thus the irradiation target 1004 is not irradiated.

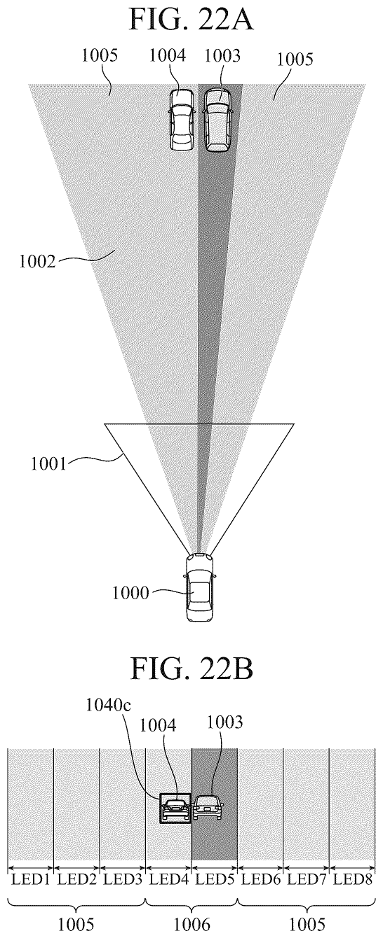

FIGS. 22A and 22B are views illustrating a state after the light shielding region 1006 is further changed.

FIG. 22A is an overhead view.

FIG. 22B is a diagram illustrating how the high beam irradiation area (the irradiation region 1005 and the light shielding region 1006) overlaps with the light shielding target 1003 and the irradiation target 1004 when looking forward from the host vehicle 1000 side.

FIG. 22 is a diagram illustrating a state after the light shielding region 1006 is further changed from the state of FIG. 21.

By the processing of step ST182, the LED 4 originally included in the light shielding LED number is out of the region where the preceding vehicle that is the light shielding target 1003 is present. Thus, the irradiation region of the LED 4 including a region 1040c where the irradiation target 1004 is present is no longer the light shielding region 1006.

With the configuration and the processing described in the fourth embodiment, the optical axis can be adjusted in such a manner that the optical axis adjustment amount is minimized while the irradiation target is irradiated.

In the light distribution control device according to the present disclosure, the optical axis adjustment amount calculating unit is further configured to adjust the optical axis adjustment amount to be smaller.

Thus, there is an effect that it is possible to further provide a light distribution control device that adjusts the optical axis adjustment amount to be smaller.

In addition, when the above configuration is applied to a headlight device or a light distribution control method, it is possible to achieve a headlight device and a light distribution control method that produce effects similar to those described above.

Here, a hardware configuration for implementing the functions of the light distribution control devices 100, 100A and 100B according to the present disclosure will be described.

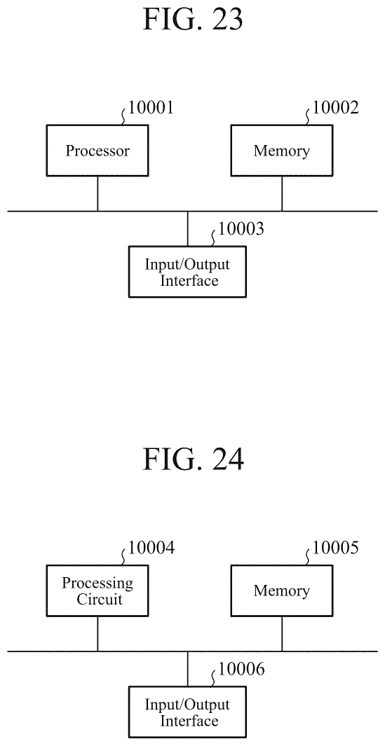

FIG. 23 is a diagram illustrating a first example of a hardware configuration for implementing the function according to the present disclosure.

FIG. 24 is a diagram illustrating a second example of a hardware configuration for implementing the function according to the present disclosure.

The light distribution control device 100 (alternatively, the light distribution control device 100A and the light distribution control device 100B) of the present disclosure is implemented by hardware as illustrated in FIG. 23 or 24.

As illustrated in FIG. 23, the light distribution control device 100 (alternatively, the light distribution control device 100A and the light distribution control device 100B) includes a processor 10001 and a memory 10002.

The processor 10001 and the memory 10002 are mounted on a computer, for example.

The memory 10002 stores a program for causing the computer to function as the object detecting unit 110 (alternatively, the object detecting unit 110B), the light shielding region determining unit 120 (alternatively, the light shielding region determining unit 120B), the optical axis adjustment amount calculating unit 130 (alternatively, the optical axis adjustment amount calculating unit 130B), the light distribution control unit 140 (alternatively, the light distribution control unit 140A and the light distribution control unit 140B), the light shielding region changing unit 150, the lane information acquiring unit 160, and a control unit not illustrated. The processor 10001 reads and executes the program stored in the memory 10002, thereby implementing the functions of the object detecting unit 110 (alternatively, the object detecting unit 110B), the light shielding region determining unit 120 (alternatively, the light shielding region determining unit 120B), the optical axis adjustment amount calculating unit 130 (alternatively, the optical axis adjustment amount calculating unit 130B), the light distribution control unit 140 (alternatively, the light distribution control unit 140A and the light distribution control unit 140B), the light shielding region changing unit 150, the lane information acquiring unit 160, and a control unit not illustrated.

Further, the map database 165 is implemented by the memory 10002 or another memory (not illustrated).

The processor 10001 uses, for example, a central processing unit (CPU), a graphics processing unit (GPU), a microprocessor, a microcontroller, a digital signal processor (DSP), or the like.

The memory 10002 may be a nonvolatile or volatile semiconductor memory such as a random access memory (RAM), a read only memory (ROM), an erasable programmable read only memory (EPROM), an electrically erasable programmable read only memory (EEPROM), a flash memory, or the like, a magnetic disk such as a hard disk or a flexible disk, or an optical disk such as a compact disc (CD) or a digital versatile disc (DVD).

The processor 10001 and the memory 10002 are connected in a state in which data can be transmitted to each other. Further, the processor 10001 and the memory 10002 are connected in a state in which data can be mutually transmitted with other hardware via an input/output interface 10003.

Alternatively, the functions of the object detecting unit 110 (alternatively, the object detecting unit 110B), the light shielding region determining unit 120 (alternatively, the light shielding region determining unit 120B), the optical axis adjustment amount calculating unit 130 (alternatively, the optical axis adjustment amount calculating unit 130B), the light distribution control unit 140 (alternatively, the light distribution control unit 140A and the light distribution control unit 140B), the light shielding region changing unit 150, the lane information acquiring unit 160, and the control unit (not illustrated) may be implemented by a dedicated processing circuit 10004 as illustrated in FIG. 24.

The processing circuit 10004 uses, for example, a single circuit, a composite circuit, a programmed processor, a parallel programmed processor, an application specific integrated circuit (ASIC), a programmable logic device (PLD), a field-programmable gate array (FPGA), a system-on-a-chip (SoC), a system large-scale integration (LSI), or the like.

Further, the map database 165 is implemented by a memory 10005 or another memory (not illustrated).

The memory 10005 may be a nonvolatile or volatile semiconductor memory such as a random access memory (RAM), a read only memory (ROM), an erasable programmable read only memory (EPROM), an electrically erasable programmable read only memory (EEPROM), a flash memory, or the like, a magnetic disk such as a hard disk or a flexible disk, or an optical disk such as a compact disc (CD) or a digital versatile disc (DVD).

The processing circuit 10004 and the memory 10005 are connected in a state in which data can be transmitted to each other. Further, the processing circuit 10004 and the memory 10005 are connected in a state in which data can be mutually transmitted with other hardware via an input/output interface 10006.

Note that the functions of the object detecting unit 110 (alternatively, the object detecting unit 110B), the light shielding region determining unit 120 (alternatively, the light shielding region determining unit 120B), the optical axis adjustment amount calculating unit 130 (alternatively, the optical axis adjustment amount calculating unit 130B), the light distribution control unit 140 (alternatively, the light distribution control unit 140A and the light distribution control unit 140B), the light shielding region changing unit 150, the lane information acquiring unit 160, and the control unit (not illustrated) may be implemented by different processing circuits, or may be collectively implemented by a processing circuit.

Alternatively, some of the functions of the object detecting unit 110 (alternatively, the object detecting unit 110B), the light shielding region determining unit 120 (alternatively, the light shielding region determining unit 120B), the optical axis adjustment amount calculating unit 130 (alternatively, the optical axis adjustment amount calculating unit 130B), the light distribution control unit 140 (alternatively, the light distribution control unit 140A and the light distribution control unit 140B), the light shielding region changing unit 150, the lane information acquiring unit 160, and the control unit (not illustrated) may be implemented by the processor 10001 and the memory 10002, and the remaining functions may be implemented by the processing circuit 10004.

Note that, in the present disclosure, it is possible to modify any component of the embodiments or omit any component of the embodiments within the scope of the disclosure.

### INDUSTRIAL APPLICABILITY

A light distribution control device according to the present disclosure can perform light distribution control in such a manner that an irradiation target can be irradiated with a high beam even when the irradiation target is included in a light shielding region in which the high beam is turned off, and hence is suitable for use in a headlight for a vehicle or the like.

### REFERENCE SIGNS LIST

1: headlight device, 10: headlight, 20: high beam unit, 30: LED module, 35: optical axis adjusting unit, 40: headlight control device, 50: lighting control device, 60: vehicle exterior sensor, 70: vehicle exterior camera, 80: positioning system, 100, 100A, 100B: light distribution control device, 110, 110B: object detecting unit, 120, 120B: light shielding region determining unit, 130, 130B: optical axis adjustment amount calculating unit, 140, 140A, 140B: light distribution control unit, 150: light shielding region changing unit, 160: lane information acquiring unit, 165: map database. 1000: host vehicle, 1001: low beam, 1002: high beam, 1003: light shielding target, 1004: irradiation target, 1004a, 1004b: irradiation target, 1004c: road installed object, 1004d: road fallen object, 1005: irradiation region, 1006: light shielding region, 1007: region, 1008: irradiation region, 1009: region, 1010: region, 1020: irradiation target, 1021: host vehicle lane, 1030: irradiation target, 1040a, 1040b, 1040c: region, 10001: processor, 10002: memory, 10003: input/output interface, 10004: processing circuit, 10005: memory, 10006: input/output interface

1. A light distribution control device that controls a high beam emitter capable of dividing a high beam irradiation area into a plurality of areas, the light distribution control device comprising:
processing circuitry configured to
detect whether or not an irradiation target to be irradiated with a high beam or a light shielding target to be shielded from the high beam is present in the high beam irradiation area;
determine a light shielding region for shielding the light shielding target when the light shielding target is detected;
calculate an optical axis adjustment amount for adjusting a direction of an optical axis of the high beam emitter in such a manner that the irradiation target is out of the light shielding region when the irradiation target is included in the light shielding region; and
control the optical axis of the high beam emitter on a basis of the optical axis adjustment amount.

2. The light distribution control device according to claim 1, wherein
the processing circuitry is configured to calculates a degree to which the irradiation target is included in the light shielding region, and calculates the optical axis adjustment amount when the degree is equal to or more than a predetermined threshold.

3. The light distribution control device according to claim 1, wherein
the processing circuitry is configured to calculates the optical axis adjustment amount when the irradiation target is included in the light shielding region and a distance between a vehicle on which the high beam emitter is mounted and the irradiation target is equal to or less than a predetermined distance.

4. The light distribution control device according to claim 1, wherein
the processing circuitry is configured to calculates the optical axis adjustment amount when an expected arrival time until a vehicle on which the high beam emitter is mounted reaches the irradiation target is equal to or less than a predetermined arrival time threshold.

5. The light distribution control device according to claim 1,
wherein the processing circuitry is further configured to
adjust the determined light shielding region in consideration of a state in which the optical axis has been adjusted.

6. The light distribution control device according to claim 1,
wherein the processing circuitry is further configured to
acquire lane information indicating a traveling lane of a vehicle on which the high beam emitter is mounted, and
selects an irradiation target on a basis of the lane information.

7. The light distribution control device according to claim 5, wherein
the processing circuitry further adjusts the optical axis adjustment amount to be smaller.

8. A headlight device comprising:
a high beam emitter capable of dividing a high beam irradiation area into a plurality of areas; and
processing circuitry configured to
detect whether or not an irradiation target to be irradiated with a high beam or a light shielding target to be shielded from the high beam is present in the high beam irradiation area:
determine a light shielding region for shielding the light shielding target when the light shielding target is detected;
calculate an optical axis adjustment amount for adjusting a direction of an optical axis of the high beam emitter in such a manner that the irradiation target is out of the light shielding region when the irradiation target is included in the light shielding region; and
control the optical axis of the high beam emitter on a basis of the optical axis adjustment amount.

9. A light distribution control method for controlling a high beam emitter capable of dividing a high beam irradiation area into a plurality of areas, the light distribution control method comprising:
detecting whether or not an irradiation target to be irradiated with a high beam or a light shielding target to be shielded from the high beam is present in the high beam irradiation area;
determining a light shielding region for shielding the light shielding target when the light shielding target is detected;
calculating an optical axis adjustment amount for adjusting a direction of an optical axis of the high beam emitter in such a manner that the irradiation target is out of the light shielding region when the irradiation target is included in the light shielding region; and
controlling the optical axis of the high beam emitter on a basis of the optical axis adjustment amount.
